(19) United States
(12) Patent Application Publication
(10) Pub. No.: US 2015/0356959 A1
(43) Pub. Date: Dec. 10, 2015

(54) Harmonica Carrier

(71) Applicant: Harry P. Tassell, III, San Diego, CA (US)

(72) Inventor: Harry P. Tassell, III, San Diego, CA (US)

(73) Assignee: CATOFONG LLC, San Diego, CA (US)

(21) Appl. No.: 14/301,074

(22) Filed: Jun. 10, 2014

(51) Int. Cl. G10G 7/00; G10D 7/12

(52) U.S. Cl. CPC G10G 7/005; G10D 7/126

(57) ABSTRACT

Provided herein is a harmonica carrier comprising two or more jointed panels and a plurality of harmonica-retaining pouches, wherein the jointed panels are capable of foldable arrangement for removable attachment to a visor of a vehicle. Also provided herein is a kit comprising the harmonica carrier thereof and a set of harmonicas.

### FIELD OF THE INVENTION

The present invention relates generally to the field of harmonica storage systems for carrying and/or transport of multiple harmonicas. The present invention also relates generally to a car visor storage system for attachment to a vehicle's sun visor.

### BACKGROUND OF THE DISCLOSURE

It is desirable for individuals and/or musicians on-the-go to be able to conveniently and securely transport multiple harmonicas (in different keys) in a carrier case. It is even more desirable for such a carrier to provide the individual with quick and easy access to each harmonica. This is particularly true today with the advent of devices designed to play music media at any time and place such as iPods, tablets, computers, smart phones, portable music players, car stereo systems, and the like. Because harmonica players are often inspired to play along and/or accompany music they hear, a carrier that also provides quick and easy access to each harmonica is highly advantageous so that the harmonica in the appropriate key may be slideably accommodated by the carrier, easily accessed by the individual and played on the ready. In addition, harmonica musicians desire a convenient means for transforming their carrier case into a display stand for their multiple harmonicas during musical performances.

Current harmonica carrier cases and/or systems function as either a traditional closed briefcase-like (hard) carrier case which fails to provide quick and easy access to the harmonicas and can be bulky and difficult to travel with, particularly when limited by the spatial constraints of stowaway compartments on trains and airplanes. Other carriers and/or systems which provide access to the harmonicas inconvenience the user by having to wear a belt or harness-like contraption. In addition, none of the current harmonica carrier cases or systems provide for removable attachment to a vehicle's sun visor.

While harmonica support and/or harmonica carrier systems and/or car visor organizers are readily available and may be found, for example in U.S. Pat. Nos. 499,831; 4,781,409; 4,844,311; 5,195,668; 5,433,362; 5,516,018; 5,653,364; 5,718,364; 5,711,469; 6,659,529; 7,638,698; and Application Number DE 202010011478 U1; none of these references disclose the embodiments of harmonica carrier disclosed herein.

Therefore, there is a need in the field for a harmonica carrier which provides a convenient and secure means for transport, carry, support, easy access, and/or display of a musician's multiple harmonicas (such as, for example, the different keys of harmonicas).

All documents and references cited herein and in the referenced patent documents, are hereby incorporated herein by reference.

### SUMMARY OF THE INVENTION

The present inventor has constructed an innovative harmonica carrier which provides a convenient and secure means for transport, carry, support, easy access, and/or display of a musician's multiple harmonicas (such as, for example, the different keys of harmonicas).

Disclosed herein is a harmonica carrier comprising two or more jointed panels and a plurality of harmonica-retaining pouches, wherein the panels are capable of foldable arrangement for removable attachment to a visor of a vehicle.

In another embodiment, the two or more jointed panels of the harmonica carrier case are three jointed panels.

In another embodiment, the plurality of harmonica-retaining pouches is six harmonica-retaining pouches.

In another embodiment, the jointed panels of the harmonica carrier are capable of foldable arrangement into a free-standing harmonica display.

In another embodiment, the jointed panels of the harmonica carrier are capable of foldable arrangement into a harmonica carrier case.

In another embodiment, the harmonica retaining pouches comprise closure means for securing a harmonica in the harmonica retaining pouch. In a further embodiment, the closure means are selected from the group consisting of Velcro®, tabs, straps, zippers, snaps, and a combination thereof.

In another embodiment, the jointed panels comprise connective means for securing the harmonica carrier to a visor. In a further embodiment, the connective means is selected from the group consisting of Velcro®, tabs, straps, elastic bands, clips, snaps, and a combination thereof.

In other embodiments, the harmonica carrier disclosed herein in the preceding paragraphs may be incorporated in kits. In addition, such kits may include a set of harmonicas.

In other embodiments, the harmonica carrier in the preceding paragraphs may additionally incorporate any of the preceding or subsequently disclosed embodiments.

The Summary of the Invention is not intended to define the claims nor is it intended to limit the scope of the invention in any manner.

Other features and advantages of the invention will be apparent from the following Drawings, Detailed Description, and the Claims.

### BRIEF DESCRIPTION OF THE FIGURES

FIG. 1 illustrates an embodiment of a harmonica carrier disclosed herein.

FIG. 2 illustrates an embodiment of a harmonica carrier disclosed herein.

FIG. 3 illustrates an embodiment of a harmonica carrier disclosed herein.

FIGS. 4A-4B illustrate embodiments of a harmonica carrier disclosed herein.

FIG. 5 illustrates an embodiment of a harmonica carrier disclosed herein.

### DETAILED DESCRIPTION

The present invention is illustrated in the drawings and description in which like elements are assigned the same reference numerals. However, while particular embodiments are illustrated in the drawings, there is no intention to limit the present invention to the specific embodiment or embodiments disclosed. Rather, the present invention is intended to cover all modifications, alternative constructions, and equivalents falling within the spirit and scope of the invention. As such, the drawings are intended to be illustrative and not restrictive.

Unless otherwise defined, all technical terms used herein have the same meaning as commonly understood by one of ordinary skill in the art to which this technology belongs.

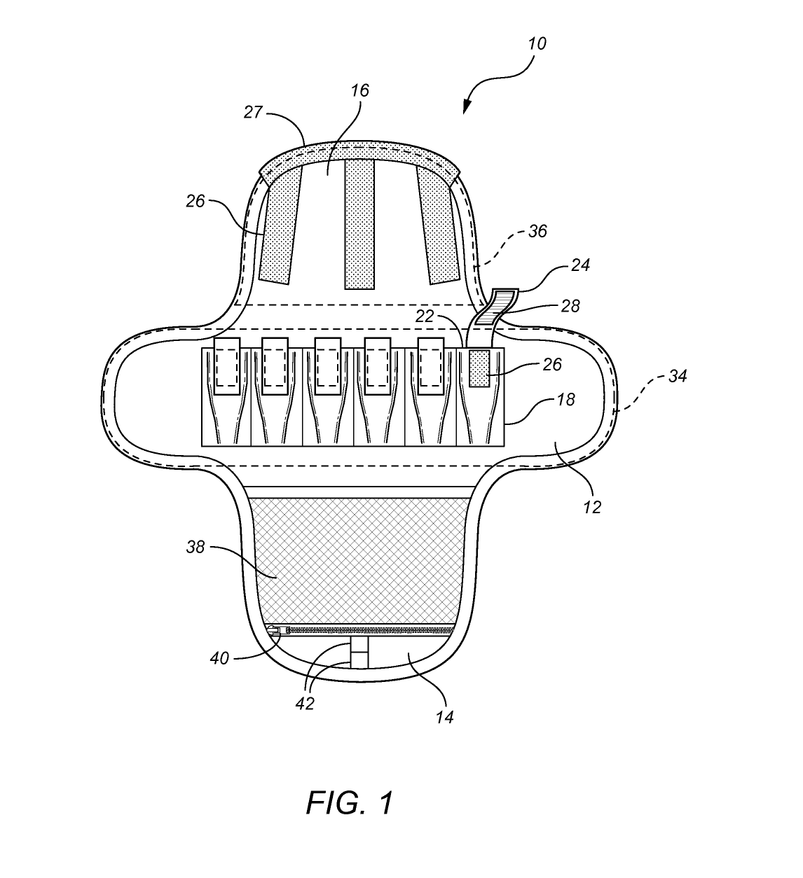

Exemplary embodiments of the present invention are depicted in FIGS. 1-5.

The harmonica carrier disclosed herein provides a convenient and secure means for transport, carry, support, easy access, and/or display of a musician's multiple harmonicas (such as, for example, the different keys of harmonicas). For the purposes of the invention, the terminology “carrier” and/or “carrier case” and/or “carry case” means and/or may be used interchangeably with the terminology “travel case” and/or “travel carrier case” and/or “travel carry case.”

For the purposes of the present invention, the terminology “harmonica” means and/or may be used interchangeably with the terms “harmonicas” or “harp” or “harps.” A harmonica is well known and readily available in the art and sometimes referred to as a French harp, blues harp, and mouth organ. Different types of harmonicas are well known and readily available in the art. These types include, without limitation, diatonic, chromatic, tremolo, octave, orchestral, and bass versions of harmonicas. Harmonicas often come in sets of harmonicas because a harmonica player will play the appropriate harmonica of a particular key depending on the key of the music to be played. For example, a diatonic harp will come in twelve (or more) versions tuned to a particular key, such as, without limitation, key of C, key of A, key of G, key of D, key of E, key of F, key of Bb, and key of Eb. In addition, for advanced and/or skillful players, there are diatonic harps in the key of high G and low F. And, therefore, a harmonica player will almost always have a need to carry multiple harmonicas, or a set of harmonicas, on-the-go.

For the purposes of the present invention, the terminology “multiple” means “more than one.” For example, a harmonica player will likely require two or more harmonicas on-the-go. While the harmonica carrier disclosed herein is shown with an exemplary six harmonica-retaining pouches, such a feature may be customized to accommodate any number of harmonica-retaining pouches.

For the purposes of the present invention, the terminology “corresponds to” means that there is a functional and/or mechanical and/or structural relationship between objects which correspond to each other. For example, the shape and size of a harmonica corresponds with and therefore slideably fits within the shape and size of a harmonica-retaining pouch of the harmonica carrier disclosed herein. In other words, such a harmonica-retaining pouch slideably accommodates a harmonica.

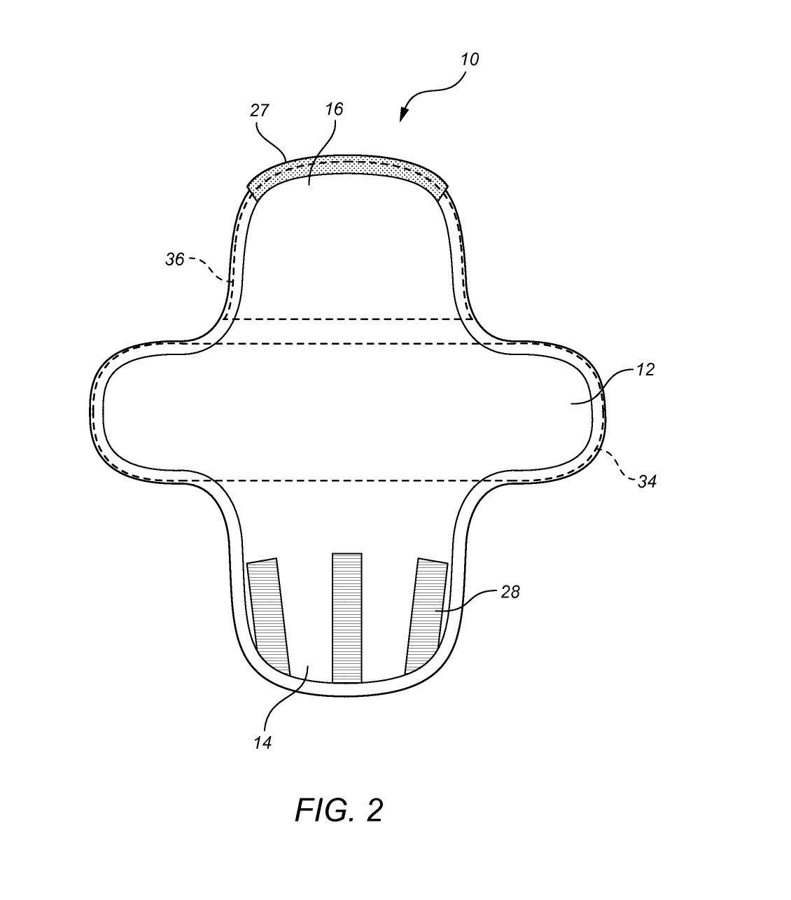

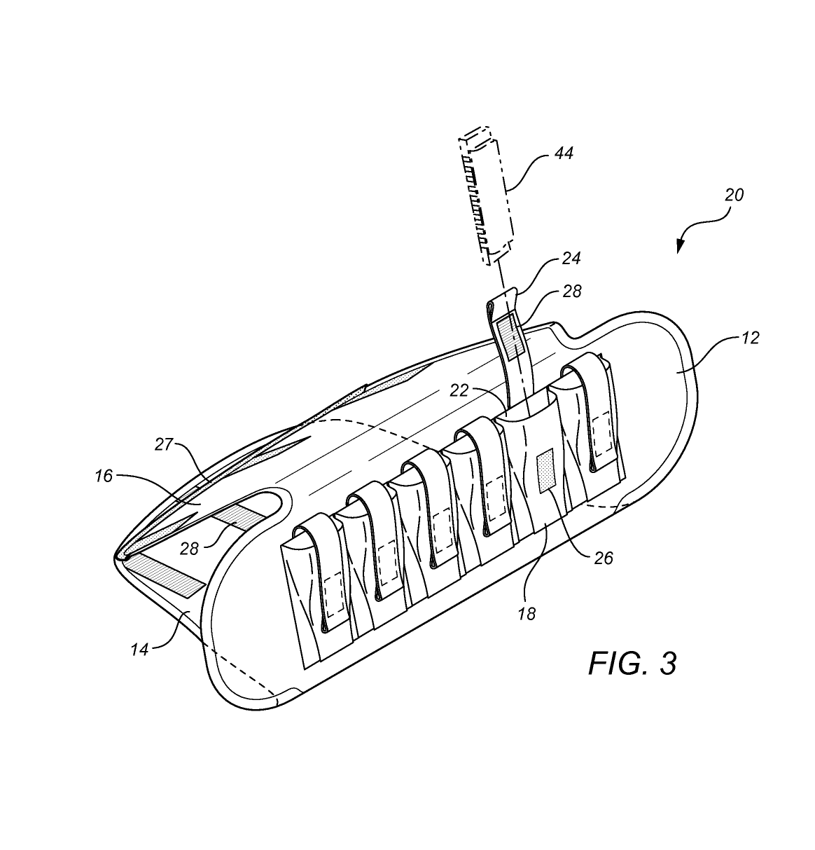

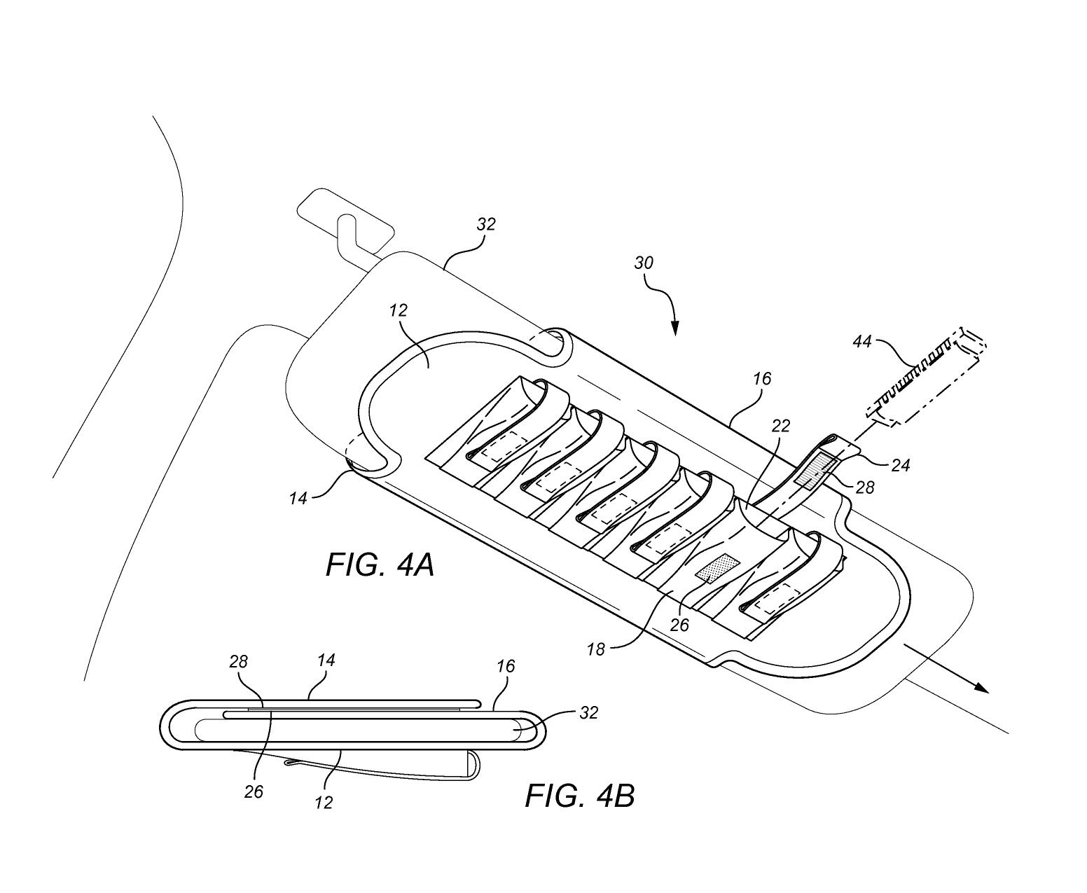

FIG. 1 shows a topside perspective view of a 10 harmonica carrier disclosed herein having 16 top, 12 middle and 14 bottom jointed panels foldably arranged in a flattened perspective. In this embodiment, the 10 harmonica carrier comprises six 18 harmonica-retaining pouches, a 40 zippered 38 mesh compartment, and 42 pen holders. The 12 middle panel of the 10 carrier case is constructed with an underlying 34 rigid board. The 16 top panel of the 10 carrier case is also constructed with an underlying 36 rigid board. The 18 harmonica-retaining pouches having 22 openings at the top side of the 18 pouches and can be secured (or closed) with 26 and 28 Velcro® 24 tabs. In this manner, the tab can be opened and the 18 pouch can slideably accommodate a corresponding 44 harmonica, which can then be secured in place with the closure of the 26 (side A) and 28 (side B) Velcro® 24 tab. In this embodiment, the 10 carrier case also includes 26 Velcro® strips on the 16 top panel and corresponding 28 Velcro® strips on the underside (shown in FIG. 2) of the 14 bottom panel. In this manner, the 12, 14, and 16 jointed panels are capable of foldable arrangement for removable attachment to a 32 visor of a vehicle (30 car visor configuration is shown in FIGS. 4A and 4B). In addition, the 10 carrier case includes 27 (side A) Velcro® along the top rim of the 16 top panel which correspondingly connects with the 28 (side B) Velcro® on the underside (shown in FIG. 2) of the 14 bottom panel. In this manner, the 12, 14, and 16 jointed panels are capable of foldable arrangement into a 20 free-standing harmonica display (as shown in FIG. 3).

FIG. 2 shows an underside perspective view of an embodiment of the 10 harmonica carrier disclosed herein having 16 top, 12 middle and 14 bottom jointed panels foldably arranged in a flattened perspective. In this embodiment, the 28 Velcro® strips on the 14 bottom panel are shown which correspond connectively with the 26 Velcro® strips on the topside of the 16 top panel (as shown in FIG. 1). In addition, the 10 carrier case shows 27 (side A) Velcro® along the top rim of the 16 top panel which correspondingly connects with the 28 (side B) Velcro® on the underside of the 14 bottom panel. In this manner, the 12, 14, and 16 jointed panels are capable of foldable arrangement into a 20 free-standing harmonica display (as shown in FIG. 3).

FIG. 3 shows a perspective view of an embodiment of the 10 harmonica carrier foldably arranged into a 20 free-standing harmonica display and the 27 Velcro® along the rim of the 16 top panel is connectively secured to the 28 Velcro® strips on the underside of the 14 bottom panel. Additionally, in this perspective view, a 44 harmonica is slideably inserted into a corresponding 18 harmonica-retaining pouch.

FIGS. 4A and 4B shows perspective and side perspective views of an exemplary 30 car visor configuration of the 10 harmonica carrier foldably arranged for removable attachment to a 32 car visor. In the perspective view of FIG. 4A, a 44 harmonica is slideably inserted into a corresponding 18 harmonica-retaining pouch for easy access of the harmonica. FIG. 4B shows the foldable arrangement of the 12, 14, and 16 jointed panels in such a manner so that the 26 Velcro® strips on the 16 top panel and corresponding 28 Velcro® strips on the underside of the 14 bottom panel connectively secure the 10 harmonica carrier to the 32 visor of the vehicle. In this 30 car visor configuration of the 10 harmonica carrier, the 12 middle panel comprising the 18 harmonica-retaining pouches are facing downward for easy access to the 44 harmonicas.

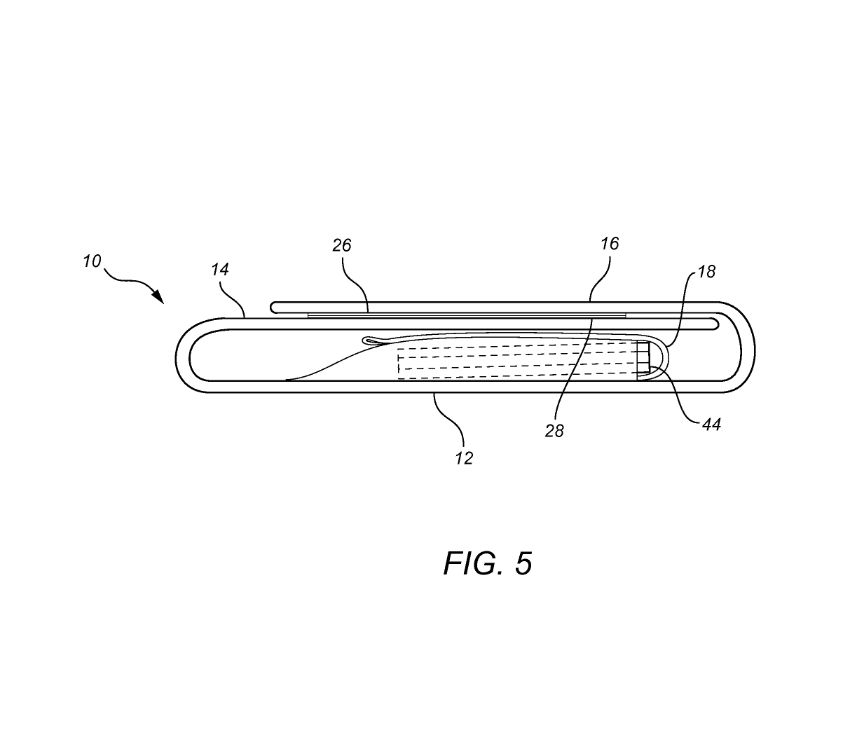

FIG. 5 shows a perspective side view of the 10 harmonica carrier foldably arranged into a harmonica carrier case. In this manner, the 14 bottom panel is folded upward and over the 12 middle panel and the 28 Velcro® strips on the underside of the 14 bottom panel connectively secure with the 26 Velcro® strips on the topside of the folded over 16 top panel. This harmonica carrier case configuration allows the 12 middle panel with the 18 harmonica retaining pouches to be protected by the 16 top and 14 bottom panels. For example, this configuration is ideal when a harmonica musician is on-the-go and/or traveling, for example, by air or train and requires a protective layer(s) over the 44 harmonicas in the 18 harmonica-retaining pouches.

The 10 harmonica carrier disclosed herein may be provided as a kit. Such kits comprise the 10 harmonica carrier and a set of 44 harmonicas, i.e., a plurality of harmonicas or multiple harmonicas, such as two or more harmonicas.

The 10 harmonica carrier disclosed herein may be manufactured and/or constructed in any size variation and/or can be scaled up or down in accordance with the customizability of the product to the customer's needs.

The 10 harmonica carrier disclosed herein may be customized on its surface(s) to include logos, graphics, designs, and/or text such as, without limitation, logos, graphics, designs, text and/or combinations thereof relating to and/or inspired from musical themes, bands, businesses, brands, and/or may include any desired logo, graphic, design and/or text whether already known or newly created.

The 10 harmonica carrier disclosed herein is made of materials well known and readily available. Materials may range from a wide variety of available materials such as, without limitation, ballistic nylon, polyester, woven mesh, Velcro®, elastic, rigid board and/or combinations thereof.

The 10 harmonica carrier of the present invention may incorporate reasonable design parameters, features, modifications, advantages, and variations that are readily apparent to those skilled in the art to which this technology pertains.

Without departing from the scope and spirit of the present invention, reasonable features, modifications, advantages, and design variations of the claimed apparatus will become readily apparent to those skilled in the art by following the guidelines set forth in the preceding detailed description and embodiments.

What is claimed is:

1. A harmonica carrier comprising two or more jointed panels and a plurality of harmonica-retaining pouches, wherein the jointed panels are capable of foldable arrangement for removable attachment to a visor of a vehicle.

2. The harmonica carrier of claim 1 comprising three jointed panels.

3. The harmonica carrier of claim 1 comprising six harmonica-retaining pouches.

4. The harmonica carrier of claim 1, wherein the jointed panels are capable of foldable arrangement into a free-standing harmonica display.

5. The harmonica carrier of claim 1, wherein the jointed panels are capable of foldable arrangement into a harmonica carrier case.

6. The harmonica carrier of claim 1, wherein the harmonica-retaining pouches comprise closure means for securing a harmonica within each harmonica-retaining pouch.

7. The harmonica carrier of claim 6, wherein the closure means is selected from the group consisting of Velcro®, tabs, straps, zippers, snaps, and a combination thereof.

8. The harmonica carrier of claim 1, comprising connective means for securing foldable arrangement of the jointed panels.

9. The harmonica carrier of claim 8, wherein the connective means is selected from the group consisting of Velcro®, tabs, straps, elastic bands, clips, snaps, and a combination thereof.

10. A kit comprising;
a. a harmonica carrier comprising two or more jointed panels and a plurality of harmonica-retaining pouches, wherein the jointed panels are capable of foldable arrangement for removable attachment to a visor of a vehicle; and
b. a set of harmonicas.
